(19) United States
(12) Patent Application Publication
(10) Pub. No.: US 2023/0088683 A1
(43) Pub. Date: Mar. 23, 2023

(54) BATTERY AND METHOD OF MANUFACTURING BATTERY

(71) Applicant: Panasonic Intellectual Property Management Co., Ltd., Osaka (JP)

(72) Inventors: Shuji ITO, Nara (JP); Yusuke ITO, Nara (JP); Masaki HIRASE, Aichi (JP); Tadaaki MATSUMURA, Shiga (JP)

(21) Appl. No.: 18/059,118

(22) Filed: Nov. 28, 2022

Related U.S. Application Data
(63) Continuation of application No. PCT/JP2021/017093, filed on Apr. 28, 2021.

(30) Foreign Application Priority Data
May 29, 2020 (JP) 2020-095083

(51) Int. Cl. H01M 10/0562; H01M 10/0525; H01M 4/134; H01M 4/66; H01M 4/1395; H01M 4/38

(52) U.S. Cl. CPC H01M 10/0562; H01M 10/0525; H01M 4/134; H01M 4/661; H01M 4/1395; H01M 4/386; H01M 2004/028

(57) ABSTRACT

A battery of the present disclosure includes a positive electrode, a negative electrode, and a solid electrolyte layer. The solid electrolyte layer is positioned between the positive electrode and the negative electrode. The solid electrolyte layer includes a solid electrolyte having lithium-ion conductivity. The negative electrode includes: a negative electrode current collector; and a negative electrode active material layer positioned between the negative electrode current collector and the solid electrolyte layer. The negative electrode active material layer has a plurality of columnar particles and is substantially free of an electrolyte. The columnar particles include silicon as a main component.

This application is a continuation of PCT/JP2021/017093 filed on Apr. 28, 2021, which claims foreign priority of Japanese Patent Application No. 2020-095083 filed on May 29, 2020, the entire contents of both of which are incorporated herein by reference.

### BACKGROUND OF THE INVENTION

### 1. Field of the Invention

The present disclosure relates to a battery and a method of manufacturing a battery.

### 2. Description of Related Art

Batteries including a solid electrolyte have attracted attention in recent years.

JP 2014-116154 A describes a negative electrode having: a negative electrode active material; a first binder that is bonded to a solid electrolyte and is inert against the solid electrolyte; and a second binder that is more excellent in binding properties to a negative electrode current collector than the first binder is. The second binder contains a highly elastic resin such as polyimide. In addition, JP 2014-116154 A describes a solid-state battery including this negative electrode.

JP 2018-120841 A describes a method of manufacturing an electrode member for all-solid-state batteries, where the electrode member has a negative electrode material portion that includes a powder of a simple substance of Si as a negative electrode active material and that is free of a binder and a solid electrolyte.

JP 2012-49023 A describes a battery in which a layer containing one or two or more elements selected from the group consisting of Cr, Ti, W, C, Ta, Au, Pt, Mn, and Mo is disposed between a current collector and an electrode layer.

WO 2001/029912 A1 describes a lithium battery including amorphous silicon as an active material and having a nonaqueous electrolyte.

ACS Applied Energy Materials, (US), 2019, Vol. 2, pp. 7005-7008 describes an all-solid-state lithium battery including a negative electrode active material layer having silicon nanoparticles.

Communications Chemistry, (UK), 2018, Vol. 1, No. 24, pp. 1-9 describes an all-solid-state lithium battery having a porous silicon film.

### SUMMARY OF THE INVENTION

In conventional arts, a battery having both a high energy density and excellent cycle characteristics is desired.

The present disclosure provides a battery including:

a positive electrode;

a negative electrode; and

a solid electrolyte layer positioned between the positive electrode and the negative electrode, wherein

the solid electrolyte layer includes a solid electrolyte having lithium-ion conductivity,

the negative electrode includes:

a negative electrode current collector; and

a negative electrode active material layer positioned between the negative electrode current collector and the solid electrolyte layer,

the negative electrode active material layer has a plurality of columnar particles and is substantially free of an electrolyte, and

the columnar particles include silicon as a main component.

According to the present disclosure, it is possible to provide a battery having both a high energy density and excellent cycle characteristics.

### BRIEF DESCRIPTION OF THE DRAWINGS

FIG. 1 is a cross-sectional view schematically showing the configuration of a battery according to the present embodiment.

FIG. 2 is an image of a cross section of a negative electrode according to Sample No. 4 observed with a scanning electron microscope (SEM).

FIG. 3 is a photograph of a surface of a negative electrode according to Sample No. 6.

FIG. 4 is a graph showing a relationship between the thickness of a negative electrode active material layer and the initial discharge capacity in batteries according to Samples No. 1 to No. 3 and Sample No. 5.

FIG. 5 is a graph showing a relationship between the thickness of the negative electrode active material layer and the initial discharge capacity per unit mass in the battery according to each sample.

FIG. 6 is a graph showing a relationship between the thickness of the negative electrode active material layer and the initial discharge capacity per unit area in the battery according to each sample.

### DETAILED DESCRIPTION

(Findings on which the Present Disclosure is Based)

In solid-state batteries, a separator formed of a solid electrolyte is typically used. In addition, for example, to enhance the ionic conductivity, a positive electrode or a negative electrode of a solid-state battery includes a solid electrolyte. A sulfide solid electrolyte is well known as a solid electrolyte. A sulfide solid electrolyte has a high lithium-ion conductivity of 10⁻³ S/cm or more. Using a sulfide solid electrolyte facilitates production of an electrode and a solid electrolyte layer by press molding or a rolling process after coating and molding. Thus, using a sulfide solid electrolyte can facilitate production of a battery. Accordingly, solid-state batteries including a sulfide solid electrolyte have attracted attention in recent years.

In the case where a positive electrode or a negative electrode does not include a solid electrolyte, the capacity of a solid-state battery cannot be fully brought out. It is considered necessary, in order to fully bring out the capacity of the solid-state battery, for the positive electrode or the negative electrode to include a large amount of a solid electrolyte. In this case, the content of an active material in the positive electrode or the negative electrode decreases. As a result, the capacity of the solid-state battery decreases.

A sulfide solid electrolyte reacts with a negative electrode current collector such as copper or nickel to form a sulfide. Formation of a sulfide increases the resistance of the battery. Thus, batteries including a sulfide solid electrolyte in a negative electrode have decreased charge and discharge cycle characteristics.

JP 2012-49023 A describes suppression of a reaction between sulfur and a current collector by disposing a reaction suppressing layer between the current collector and an electrode body. However, the battery described in JP 2012-49023 A causes an increase in manufacturing cost.

JP 2014-116154 A describes a solid-state battery in which a compound including silicon is used as a negative electrode active material. However, silicon is generally considered to have a poor ionic conductivity. Thus, the solid-state battery according to JP 2014-116154 A is considered to have low rate characteristics.

JP 2018-120841 A describes a method of manufacturing a battery in which particles of a silicon material included in a negative electrode are bonded to each other by applying a confining pressure of 100 MPa or more to an assembly. However, this battery is considered to have a low discharge capacity.

ACS Applied Energy Materials, (US), 2019, Vol. 2, pp. 7005-7008 describes a negative electrode in which silicon in thin film state is formed on a stainless steel substrate. However, it is difficult to increase the thickness of the silicon thin film because of a low adhesion between the stainless steel substrate and silicon. As a result, a battery including this negative electrode is considered to have a low discharge capacity.

WO 2001/029912 A1 describes a lithium-ion secondary battery in which a negative electrode having a copper foil and a silicon thin film formed on the copper foil and a nonaqueous electrolyte solution are used. Batteries including a nonaqueous electrolyte solution have a problem that, due to charge and discharge, silicon included in a negative electrode active material and a nonaqueous electrolyte solution react with each other to deactivate the negative electrode active material, for example.

In addition, in batteries including a nonaqueous electrolyte solution, a nonaqueous electrolyte solution permeates into a negative electrode active material layer, so that an ion conduction path is formed over the entire negative electrode active material layer. Thus, batteries including a nonaqueous electrolyte solution exhibit an excellent initial discharge capacity. However, in batteries including a solid electrolyte, an ion conduction path can be formed only on the contact surface between a negative electrode active material layer and a solid electrolyte layer. Thus, it is considered that the larger the film thickness of the negative electrode active material layer is, the lower the initial discharge capacity of such batteries is. This is a problem unique to solid-state batteries.

As a result of intensive studies, the present inventors have found that it is possible to obtain a battery having both a high energy density and excellent cycle characteristics even by using, as a solid electrolyte, a compound including silicon for a negative electrode active material, and thus have resulted in completion of the present disclosure.

### (Outline of One Aspect According to the Present Disclosure)

A battery according to a first aspect of the present disclosure includes:

a positive electrode;

a negative electrode; and

a solid electrolyte layer positioned between the positive electrode and the negative electrode, wherein

the solid electrolyte layer includes a solid electrolyte having lithium-ion conductivity,

the negative electrode includes:

a negative electrode current collector; and

a negative electrode active material layer positioned between the negative electrode current collector and the solid electrolyte layer,

the negative electrode active material layer has a plurality of columnar particles and is substantially free of an electrolyte, and

the columnar particles include silicon as a main component.

According to the first aspect, it is possible to obtain a battery having both a high energy density and excellent cycle characteristics.

In a second aspect of the present disclosure, for example, in the battery according to the first aspect, the negative electrode active material layer may have a structure in which the plurality of columnar particles are arrayed along a surface of the negative electrode current collector to cover the surface. According to such a configuration, it is possible to more reliably obtain a battery having a high energy density.

In a third aspect of the present disclosure, for example, in the battery according to the first or second aspect, the negative electrode active material layer may have a thickness of 4 μm or more and 20 μm or less. According to such a configuration, the initial discharge capacity of the battery is less likely to decrease.

In a fourth aspect of the present disclosure, for example, in the battery according to any one of the first to third aspects, a content of the silicon in the negative electrode active material layer may be 95 mass % or more. According to such a configuration, it is possible to enhance the initial discharge capacity of the battery.

In a fifth aspect of the present disclosure, for example, in the battery according to any one of the first to fourth aspects, the solid electrolyte may include a sulfide. According to such a configuration, it is possible to provide a battery having an excellent lithium-ion conductivity.

In a sixth aspect of the present disclosure, for example, in the battery according to any one of the first to fifth aspects, the negative electrode current collector may include, as a main component, copper or nickel.

In a seventh aspect of the present disclosure, for example, in the battery according to the sixth aspect, the negative electrode current collector may include copper as the main component.

According to the sixth and seventh aspects, it is possible to more reliably obtain a battery having a high energy density.

In an eighth aspect of the present disclosure, for example, in the battery according to any one of the first to seventh aspects, the negative electrode active material layer may include copper. According to such a configuration, it is possible to more reliably enhance the electron conductivity of the negative electrode active material layer.

In a ninth aspect of the present disclosure, for example, in the battery according to any one of the first to eighth aspects, when constant-current charge is performed to −0.62 V at a current value of 0.05 C by using the negative electrode and a LiIn counter electrode and subsequently constant-current discharge is performed to 1.4 V at a current value of 0.05 C, a discharge capacity of the battery may be 2500 mAh/g or more and 3 mAh/cm² or more.

In a tenth aspect of the present disclosure, for example, in the battery according to the ninth aspect, the discharge capacity of the battery in the constant-current discharge may be 3000 mAh/g or more and 4 mAh/cm² or more.

In an eleventh aspect of the present disclosure, for example, in the battery according to the tenth aspect, the discharge capacity of the battery in the constant-current discharge may be 3000 mAh/g or more and 5 mAh/cm² or more.

The battery according to any one of the ninth to eleventh aspects can more reliably have a high discharge capacity.

A battery manufacturing method according to a twelfth aspect of the present disclosure is a method of manufacturing the battery according to any one of the first to eleventh aspects, the method including depositing the silicon on the negative electrode current collector by sputtering.

According to such a configuration, it is possible to form a silicon thin film on a negative electrode current collector.

In a thirteenth aspect of the present disclosure, for example, the method according to the twelfth aspect may include heat-treating the silicon at 300° C. or less after the sputtering. Accordingly, it is possible to enhance the electron conductivity of the battery.

An embodiment of the present disclosure will be described below with reference to the drawings. The present disclosure is not limited to the following embodiment.

### Embodiment

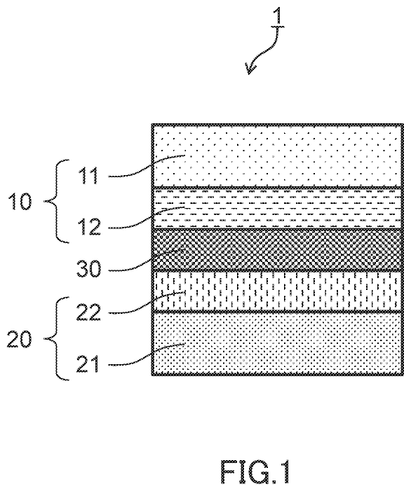

FIG. 1 is a cross-sectional view schematically showing the configuration of a battery according to the present embodiment. As shown in FIG. 1, an all-solid-state battery 1 according to the present embodiment includes a positive electrode 10, a negative electrode 20, and a solid electrolyte layer 30. The negative electrode 20 includes a negative electrode current collector 21 and a negative electrode active material layer 22. The negative electrode active material layer 22 is positioned between the negative electrode current collector 21 and the solid electrolyte layer 30. The solid electrolyte layer 30 is positioned between the positive electrode 10 and the negative electrode 20. The solid electrolyte layer 30 includes a solid electrolyte having lithium-ion conductivity. The negative electrode active material layer 22 has a plurality of columnar particles. The negative electrode active material layer 22 is substantially free of an electrolyte. The columnar particles include silicon as a main component. In the present description, the phrase “substantially free of an electrolyte” is intended to allow incorporation of a minute amount of the above electrolyte, and the incorporation amount of the above electrolyte with respect to the total mass of the negative electrode active material layer 22 is, for example, 5 mass % or less. In the present description, the term “electrolyte” includes a solid electrolyte and a nonaqueous electrolyte.

In the present embodiment, for example, unevenness is provided on the surface of the negative electrode current collector 21. In other words, the negative electrode current collector 21 has a plurality of protruding portions on its surface. The plurality of protruding portions may be arrayed irregularly or may be arrayed regularly.

The columnar particles are, for example, particles extending in the thickness direction of the negative electrode current collector 21 from the unevenness provided on the surface of the negative electrode current collector 21. The columnar particles may be formed in a protruding region of the negative electrode current collector 21. However, the columnar particles are not necessarily limited to particles extending in the thickness direction of the negative electrode current collector 21 from the protruding portions of the negative electrode current collector 21 or particles formed in the protruding region of the negative electrode current collector 21. The columnar particles include, for example, columnar particles extending in the thickness direction of the negative electrode current collector 21 from the protruding portions of the negative electrode current collector 21 or particles stacked on particles formed in the protruding region of the negative electrode current collector 21. The shape of the columnar particles is not limited to a specific shape. The columnar particles do not necessarily need to have a shape such as a column. In some cases, the columnar particles may be spherical, acicular, or ellipsoidal. The size of the columnar particles is not limited to a specific size.

One or more columnar particles including a negative electrode active material are formed with each of the plurality of protruding portions as the starting point. The columnar particles extend in the thickness direction of the negative electrode current collector 21. The directions in which the columnar particles are formed may be the same or different. The columnar particles are each supported by the protruding portion of the negative electrode current collector 21. Adjacent columnar particles may have a gap therebetween. When the negative electrode active material layer is separated by a break or a gap into a plurality of portions, the portions are each referred to as a “columnar particle”. In other words, the negative electrode active material layer 22 is composed of a group of columnar particles filling the surface of the negative electrode current collector 21. According to such a configuration, it is possible to more reliably obtain the all-solid-state battery 1 having a high energy density. In addition, according to such a configuration, the surface of the negative electrode current collector 21 is substantially free of an electrolyte. Thus, charge and discharge are less likely to generate a substance that can become a resistance in ion conduction. As a result, it is possible to more reliably obtain the all-solid-state battery 1 having excellent cycle characteristics.

ACS Applied Energy Materials, (US), 2019, Vol. 2, pp. 7005-7008 describes a negative electrode active material layer having silicon nanoparticles. In contrast, in the all-solid-state battery 1 according to the present embodiment, since the negative electrode active material layer 22 has the silicon columnar particles, the solid electrolyte is less likely to enter the negative electrode active material layer 22. Thus, the solid electrolyte is less likely to come into contact with the surface of the negative electrode current collector 21. As a result, charge and discharge are less likely to generate, on the contact surface between the negative electrode current collector 21 and the negative electrode active material layer 22, a material that can become a resistance. As a result, it is possible to more reliably obtain the all-solid-state battery 1 having excellent cycle characteristics. In addition, in the negative electrode active material layer 22 of the all-solid-state battery 1 according to the present embodiment, the negative electrode active material has a small surface area compared with that of the negative electrode active material layer of the battery described in ACS Applied Energy Materials, (US), 2019, Vol. 2, pp. 7005-7008. That is, in the all-solid-state battery 1 according to the present embodiment, the negative electrode active material layer 22 is dense. In the present embodiment, this facilitates Li ions to conduct inside the negative electrode active material layer 22. Accordingly, it is possible to obtain the all-solid-state battery 1 that can have a more fully enhanced discharge capacity and it is possible to obtain the all-solid-state battery 1 that has a high energy density.

As described above, the negative electrode active material layer 22 includes silicon as a main component. In detail, the columnar particles include silicon as a main component. From the viewpoint of energy density, the content of silicon in the negative electrode active material layer 22 may be 80 mass % or more, 85 mass % or more, 90 mass % or more, or 95 mass % or more. In detail, the content of silicon in the columnar particles may be 80 mass % or more, 85 mass % or more, 90 mass % or more, or 95 mass % or more. According to such a configuration, it is possible to enhance the initial discharge capacity of the battery. The content of silicon can be determined, for example, by inductively coupled plasma (ICP) emission spectrometry. In the present description, the term “main component” refers to a component contained in the largest amount in mass ratio.

The negative electrode active material layer 22 may further include inevitable impurities, or a starting material used in forming the negative electrode active material layer 22, a by-product, and a decomposition product. The negative electrode active material layer 22 may include, for example, oxygen, carbon, or a dissimilar metal.

The negative electrode active material layer 22 may consist substantially of silicon. The phrase “consist substantially of silicon” is intended to allow incorporation of a minute amount of inevitable impurities. The negative electrode active material layer 22 may consist of silicon. The columnar particles may consist substantially of silicon. The columnar particles may consist of silicon.

In the all-solid-state battery 1 according to the present embodiment, the negative electrode active material layer 22 has, for example, a structure in which the plurality of columnar particles are disposed along the surface of the negative electrode current collector 21 to cover the surface. In other words, the negative electrode active material layer 22 is formed by an agglomerate of the plurality of columnar particles covering the surface of the negative electrode current collector 21. The negative electrode active material layer 22 can be formed as a single layer of the plurality of columnar particles. Accordingly, the solid electrolyte layer 30 and the negative electrode current collector 21 are less likely to come into contact with each other, so that the all-solid-state battery 1 having a high energy density can be more reliably obtained.

In the columnar particles of the negative electrode active material layer 22, silicon forms a continuous phase, for example. Accordingly, the conduction path for Li ions can be formed in the continuous phase of silicon, so that Li ions can easily conduct inside the negative electrode active material layer 22.

The all-solid-state battery 1 may include a part of the solid electrolyte in the negative electrode active material layer 22 due to charge and discharge. However, the negative electrode active material layer 22 may be substantially free of the solid electrolyte immediately after production of the all-solid-state battery 1 and before the initial charge and discharge. According to such a configuration, it is possible to enhance the content of silicon in the negative electrode active material layer 22, thereby obtaining the all-solid-state battery 1 having a high energy density. In addition, according to such a configuration, the negative electrode active material layer 22 is, for example, substantially free of a solid electrolyte such as a sulfide solid electrolyte, so that the contact between the metal of the negative electrode current collector and the sulfide solid electrolyte can be reduced. As a result, generation of a sulfide due to charge and discharge of the all-solid-state battery 1 can be suppressed, so that it is possible to provide the all-solid-state battery 1 having rate characteristics and cycle characteristics that are maintained for a long time.

The average thickness of the negative electrode active material layer 22 is, for example, 4 μm or more. The upper limit for the thickness of the negative electrode active material layer 22 may be 20 μm or 10 μm. According to such a configuration, it is possible to obtain the all-solid-state battery 1 having the initial discharge capacity that is less likely to decrease. The thickness of the negative electrode active material layer 22 can be determined, specifically, by observing a cross section of the all-solid-state battery 1 with a scanning electron microscope (SEM) and calculating the average of measured values at any 50 positions.

In the negative electrode active material layer 22, the average width of the columnar particles is, for example, 3 μm or more and 30 μm or less. The width of a columnar particle means the length of the columnar particle in a direction intersecting with a direction in which the negative electrode current collector 21 and the negative electrode active material layer 22 are stacked. The width of the columnar particle can be determined, for example, by observing a cross section of the all-solid-state battery 1 with an SEM. Specifically, any 50 columnar particles are selected from the columnar particles observed in an SEM image of the negative electrode active material layer 22. For one columnar particle, its maximum width is defined as the width of the columnar particle. From the measured values of the maximum width for any 50 columnar particles, the average width of the columnar particles can be determined.

Examples of the negative electrode current collector 21 include copper, nickel, stainless steel, and alloy foils including these elements as a main component. The negative electrode current collector 21 may include, as a main component, copper or nickel. Alternatively, the negative electrode current collector 21 may include copper as the main component. According to such a configuration, it is possible to more reliably obtain the all-solid-state battery 1 having a high energy density.

From the viewpoint of electron conductivity and cost, the negative electrode current collector 21 may be copper or a copper alloy. Copper forms a copper sulfide by reacting with, for example, a sulfide solid electrolyte. A copper sulfide is generally a material that can be a resistance in ion conduction. In the all-solid-state battery 1 according to the present embodiment, the negative electrode active material layer 22 is substantially free of an electrolyte such as a solid electrolyte. In addition, in the all-solid-state battery 1 according to the present embodiment, the surface of the negative electrode current collector 21 is substantially free of an electrolyte. The metal component included in the negative electrode current collector 21 and a solid electrolyte are less likely to react with each other, so that charge and discharge of the all-solid-state battery 1 are less likely to generate copper sulfide, for example. Thus, in the all-solid-state battery 1 according to the present embodiment, copper can be used as the negative electrode current collector 21.

A copper foil may be used as the negative electrode current collector 21. An example of a copper foil is an electrolytic copper foil. An electrolytic copper foil is obtained, for example, in the following manner. First, a metallic drum is immersed in an electrolyte solution in which copper ions are dissolved. A current is applied while rotating this drum to deposit copper on the surface of the drum. The deposited copper is peeled off. Thus, an electrolytic copper foil is obtained. One or both surfaces of the electrolytic copper foil may be subjected to a roughening treatment or a surface treatment.

The surface of the negative electrode current collector 21 may be roughened. According to such a configuration, it is possible to form silicon particles in a columnar shape on the negative electrode current collector 21 and to enhance the adhesion between the columnar particles and the negative electrode current collector 21. One method of roughening the surface of the negative electrode current collector 21 is to deposit a metal through an electrolytic process and roughen the surface of the metal.

The arithmetic average roughness Ra of the surface of the negative electrode current collector 21 is, for example, 0.001 μm or more. The arithmetic average roughness Ra of the surface of the negative electrode current collector 21 may be 0.01 μm or more and 1 μm or less, or may be 0.1 μm or more and 0.5 μm or less. By adjusting the arithmetic average roughness Ra of the negative electrode current collector 21, it is possible to increase the contact area between the negative electrode current collector 21 and the negative electrode active material layer 22. Accordingly, the negative electrode active material layer 22 is less likely to be peeled off from the negative electrode current collector 21. As a result, the all-solid-state battery 1 can more reliably have high cycle characteristics. The arithmetic average roughness Ra is the value specified in Japanese Industrial Standards (JIS) B 0601: 2013, and can be measured, for example, with a laser microscope.

The thickness of the negative electrode current collector 21 is not limited to a specific value. The thickness may be 5 μm or more and 50 μm or less, or may be 8 μm or more and 25 μm or less.

The method of depositing silicon on the negative electrode current collector 21 is not limited to a specific method. Examples of the method include a chemical vapor deposition (CVD) method, a sputtering method, a deposition method, a thermal spraying method, and a plating method. According to these methods, a silicon thin film can be formed on the negative electrode current collector.

After the silicon columnar particles are formed on the negative electrode current collector 21 by the above method, the negative electrode 20 is heated, for example. It is known that copper is an element that easily diffuses into silicon. Thus, in the case where copper is used for the negative electrode current collector 21, the negative electrode active material layer 22 can include copper due to charge and discharge of the all-solid-state battery 1. The copper has malleability. Owing to inclusion of copper in the negative electrode active material layer 22, voids or cracks are less likely to occur in the negative electrode active material layer 22 even with a change in volume of the negative electrode active material due to the charge and discharge. In addition, a contact failure is less likely to occur between the negative electrode active material layer 22 and the negative electrode current collector 21 even with a change in volume of the negative electrode active material due to the charge and discharge, so that the adhesion between the negative electrode current collector 21 and the silicon columnar particles can be enhanced. Accordingly, the all-solid-state battery 1 can more reliably have high cycle characteristics.

The temperature at which the negative electrode 20 is heated is, for example, 300° C. or less. At such a temperature, silicon and copper included in the negative electrode active material layer 22 are less likely to form an intermetallic compound. As a result, the all-solid-state battery 1 can more reliably have an enhanced electron conductivity. The lower limit for the temperature at which the negative electrode 20 is heated is not limited to a specific value. The lower limit for the temperature may be 150° C. or 250° C.

The solid electrolyte layer 30 includes a solid electrolyte having lithium-ion conductivity. Examples of solid electrolytes used for the solid electrolyte layer 30 include sulfide solid electrolytes, oxide solid electrolytes, halide solid electrolytes, complex hydride solid electrolytes, and polymer solid electrolytes. The solid electrolyte includes, for example, a sulfide. According to such a configuration, it is possible to obtain the all-solid-state battery 1 that can have characteristics such as a high energy density, high rate characteristics, and high cycle characteristics.

Examples of sulfide solid electrolytes include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂. LiX, Li₂O, MOₚ, or Li_{q}MOᵣ may be added to these solid electrolytes. The element X includes at least one selected from the group consisting of F, Cl, Br, and I. The element M includes at least one selected from the group consisting of P, Si, Ge, B, Al, Ga, In, Fe, and Zn. The symbols p, q, and r are natural numbers.

Owing to inclusion of a sulfide solid electrolyte in the solid electrolyte layer 30, it is possible to enhance the adhesion between the solid electrolyte layer 30 and the negative electrode active material layer 22. As a result, it is possible to enhance the ionic conductivity on the contact surface between the solid electrolyte layer 30 and the negative electrode active material layer 22. In addition, according to such a configuration, it is possible to obtain the all-solid-state battery 1 having high rate characteristics.

Examples of oxide solid electrolytes include: Na Super Ionic Conductor (NASICON) solid electrolytes typified by LiTi₂(PO₄)₃ and element-substituted substances thereof, perovskite solid electrolytes including (LaLi)TiO₃; Li Super Ionic Conductor (LISICON) solid electrolytes typified by Li₁₄ZnGe₄O₁₆, Li₄SiO₄, LiGeO₄, and element-substituted substances thereof, garnet solid electrolytes typified by Li₇La₃Zr₂O₁₂ and element-substituted substances thereof, Li₃N and H-substituted substances thereof, Li₃PO₄ and N-substituted substances thereof, and glass and glass ceramics in which Li₂SO₄, Li₂CO₃, or the like has been added to a base including a Li—B—O compound such as LiBO₂ or Li₃BO₃.

An example of halide solid electrolytes is a material represented by a composition formula Li_{α}M_{β}X_{γ}. The symbols α, β, and γ are values greater than 0. The element M includes at least one of a metalloid element and a metal element other than Li. The element X is one or two or more elements selected from the group consisting of F, Cl, Br, and I. Here, metalloid elements are B, Si, Ge, As, Sb, and Te. Metal elements are all the elements included in Groups 1 to 12 of the periodic table except for hydrogen and all the elements included in Groups 13 to 16 of the periodic table except for B, Si, Ge, As, Sb, Te, C, N, P, O, S, and Se. In other words, metalloid elements and metal elements are a group of elements that can become cations when forming an inorganic compound with a halogen compound.

Specific examples of halide solid electrolytes include Li₃YX₆, Li₂MgX₄, Li₂FeX₄, Li(Al, Ga, In)X₄, and Li₃(Al, Ga, In)X₆. The notation “(Al, Ga, In)” represents at least one element selected from the group consisting of elements in parentheses. In other words, “(Al, Ga, In)” is synonymous with “at least one selected from the group consisting of Al, Ga, and In”. The same applies to other elements.

Examples of complex hydride solid electrolytes include LiBH₄—LiI and LiBH₄—P₂S₅.

An example of a polymer solid electrolyte is a compound of a polymer compound and a lithium salt. The polymer compound may have an ethylene oxide structure. Owing to having an ethylene oxide structure, the polymer compound can contain a large amount of lithium salt, thereby further increasing the ionic conductivity. Examples of lithium salts include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. As the lithium salt, at least one lithium salt selected from the group consisting of the above lithium salts can be used alone. Alternatively, as the lithium salt, a mixture of two or more lithium salts selected from the group consisting of the above lithium salts can be used.

The shape of the solid electrolyte is, for example, acicular, particulate, spherical, or ellipsoidal. In the case where the solid electrolyte is particulate or spherical, its average particle diameter is, for example, 0.1 μm or more and 50 μm or less.

The positive electrode 10 includes a positive electrode current collector 11 and a positive electrode active material layer 12. The positive electrode active material layer 12 is positioned between the positive electrode current collector 11 and the solid electrolyte layer 30.

The material of the positive electrode current collector 11 is not limited to a specific material, and materials generally used for batteries can be used. Examples of the material of the positive electrode current collector 11 include copper, a copper alloy, aluminum, an aluminum alloy, stainless steel, nickel, titanium, carbon, lithium, indium, and a conductive resin. The shape of the positive electrode current collector 11 is also not limited to a specific shape. Examples of the shape include a foil, a film, and a sheet. Unevenness may be imparted to the surface of the positive electrode current collector 11.

The positive electrode active material layer 12 includes, for example, a positive electrode active material. The positive electrode active material includes, for example, a material having a property of occluding and releasing metal ions such as lithium ions. The positive electrode active material may be, for example, a material including: at least one selected from the group consisting of cobalt, nickel, manganese, and aluminum; lithium; and oxygen. Examples of positive electrode active materials include lithium-containing transition metal oxides, transition metal fluorides, polyanion materials, fluorinated polyanion materials, transition metal sulfides, transition metal oxysulfides, and transition metal oxynitrides. Examples of lithium-containing transition metal oxides include Li(Ni, Co, Al)O₂, Li(Ni, Co, Mn)O₂, and LiCoO₂. In particular, in the case where a lithium-containing transition metal oxide is used as the positive electrode active material, the manufacturing cost can be reduced and the average discharge voltage can be increased. To increase the energy density of the battery, the positive electrode active material may be lithium cobalt oxide, lithium nickel cobalt manganese oxide, or lithium nickel cobalt aluminum oxide. The positive electrode active material may be LiCoO₂, Li(Ni, Co, Mn)O₂, or Li(Ni, Co, Al)O₂. The positive electrode active material layer 12 may further include at least one selected from the group consisting of a solid electrolyte, a conductive material, and a binder, as necessary. The positive electrode active material layer 12 may include a mixed material of positive electrode active material particles and solid electrolyte particles.

The shape of the positive electrode active material is, for example, particulate. In the case where the positive electrode active material is particulate, the positive electrode active material has an average particle diameter of, for example, 100 nm or more and 50 μm or less.

The average charge and discharge potential of the positive electrode active material may be 3.7 V vs. Li/Li⁺ or more with respect to the oxidation-reduction potential of a Li metal. The average charge and discharge potential of the positive electrode active material can be determined from, for example, the average voltage in Li desorption from and Li insertion into the positive electrode active material by using the Li metal as the counter electrode. In the case where a material other than the Li metal is used as the counter electrode, the average potential may be determined by adding the potential of the material used as the counter electrode versus the Li metal to the charge and discharge curve. In the case where a material other than the Li metal is used as the counter electrode, the all-solid-state battery may be charged and discharged at a relatively low current value in consideration of ohmic loss.

At least one selected from the group consisting of the positive electrode 10, the solid electrolyte layer 30, and the negative electrode 20 may contain a binder for the purpose of enhancing the adhesion between particles. The binder is used, for example, to enhance the binding properties of the materials of the electrodes. Examples of binders include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethylcellulose. Furthermore, as the binder can also be used a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. Moreover, a mixture of two or more selected from these may be used as the binder.

At least one of the positive electrode 10 and the negative electrode 20 may contain a conductive additive for the purpose of enhancing the electron conductivity. Examples of conductive additives include graphites, carbon blacks, conductive fibers, metal powders, conductive whiskers, conductive metal oxides, and conductive polymers. Examples of graphites include natural graphite and artificial graphite. Examples of carbon blacks include acetylene black and Ketjenblack. Examples of conductive fibers include carbon fibers and metal fibers. Examples of metal powders include a fluorinated carbon powder and an aluminum powder. Examples of conductive whiskers include zinc oxide whiskers and potassium titanate whiskers. Examples of conductive metal oxides include titanium oxide. Examples of conductive polymer compounds include a polyaniline compound, a polypyrrole compound, and a polythiophene compound. Using a conductive additive including carbon can seek cost reduction.

Examples of the shape of the all-solid-state battery 1 include a coin type, a cylindrical type, a prismatic type, a sheet type, a button type, a flat type, and a stacked type.

The operating temperature of the all-solid-state battery 1 is not limited to a specific temperature. The temperature is, for example, −50° C. or more and 100° C. or less. The higher the operating temperature of the all-solid-state battery 1 is, the better the ionic conductivity can be enhanced. Accordingly, the all-solid-state battery 1 can operate at a high power.

Constant-current charge of the all-solid-state battery 1 according to the present embodiment is performed to −0.62 V at a current value of 0.05 C by, for example, using the negative electrode 20 and a LiIn counter electrode. Subsequently, constant-current discharge of the all-solid-state battery 1 is performed to 1.4 V at a current value of 0.05 C. At this time, the discharge capacity of the all-solid-state battery 1 is 2500 mAh/g or more and 3 mAh/cm² or more. Since the all-solid-state battery 1 has the negative electrode described above, it is possible to provide the all-solid-state battery 1 that can more reliably have a high discharge capacity.

In the above charge and discharge test, the discharge capacity of the all-solid-state battery 1 may be 3000 mAh/g or more and 4 mAh/cm² or more. In the above charge and discharge test, the discharge capacity of the all-solid-state battery 1 may be 3000 mAh/g or more and 5 mAh/cm² or more. Since the all-solid-state battery 1 has the negative electrode described above, it is possible to provide the all-solid-state battery 1 that can more reliably have a high discharge capacity.

### EXAMPLES

The present disclosure will be described in detail below. However, the present invention is not limited to the following examples.

### <<Sample No. 1>>

### [Production of Negative Electrode]

A negative electrode current collector used was an electrolytic copper foil having a surface roughened by depositing copper through an electrolytic process. A silicon thin film was formed on the negative electrode current collector with an RF sputtering apparatus to produce a negative electrode according to Sample No. 1. The conditions for silicon thin film formation are shown in Table 1. In Table 1, the thickness of the silicon thin film was calculated by calculating the surface density of silicon by inductively coupled plasma (ICP) emission spectrometry and dividing the value of the surface density by the true density of silicon (2.33 g/cm³). The content of silicon in a negative electrode active material layer according to Sample No. 1 was 95 mass % or more.

### [Production of Sulfide Solid Electrolyte Material]

In a glove box under an argon atmosphere with a dew point of −60° C. or less, Li₂S and P₂S₅ were weighed in a mortar at the molar ratio of Li₂S:P₂S₅=75:25. These were pulverized for mixing in the mortar to obtain a mixture. The obtained mixture was put into a planetary ball mill P-7 manufactured by Fritsch GmbH for a milling process at 510 revolutions/minute (rpm) for 10 hours. Thus, a glassy solid electrolyte was obtained. The glassy solid electrolyte was heat-treated under an inert gas atmosphere at 270° C. for 2 hours. Thus, a glass-ceramic solid electrolyte Li₂S—P₂S₅ was obtained.

### [Production of Battery]

An amount of 80 mg of the solid electrolyte was weighed and added to an electrically insulating cylinder. The negative electrode according to Sample No. 1 punched out to have a diameter of 9.4 mm was added to the cylinder, and pressure-molding was performed at 370 MPa to produce a stack composed of the negative electrode and a solid electrolyte layer.

Next, on the solid electrolyte layer of the stack, metallic indium having a thickness of 200 m, metallic lithium having a thickness of 300 m, and metallic indium having a thickness of 200 m were disposed in this order to produce a three-layered stack composed of the negative electrode, the solid electrolyte layer, and an indium-lithium-indium layer. Next, this three-layered stack was pressure-molded at 80 MPa to produce a two-electrode electrochemical cell composed of the negative electrode, the solid electrolyte layer, and a counter electrode.

Next, current collectors including stainless steel were disposed on the top and the bottom of the two-electrode electrochemical cell, and then current collector leads were attached to the current collectors.

Next, an electrically insulating ferrule was used to block and seal the inside of the electrically insulating outer cylinder from the outside air atmosphere.

The two-electrode electrochemical cell was sandwiched with four bolts from above and below, and a pressure of 150 MPa was applied to the stack. Thus, a battery according to Sample No. 1 having the negative electrode, the solid electrolyte layer, and the counter electrode was obtained. The battery according to Sample No. 1 had the negative electrode as the working electrode.

### [Charge and Discharge Test]

A charge and discharge test was performed for the battery according to Sample No. 1 under the following conditions.

The battery was placed in a thermostatic chamber at 25° C.

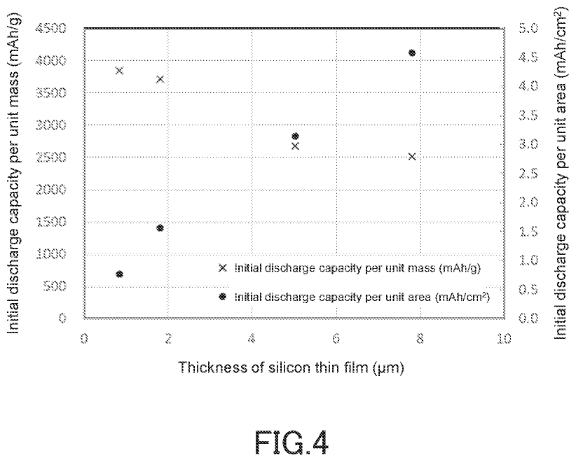

The theoretical capacity of silicon in the negative electrode active material is 4200 mAh/g. With respect to the capacity equal to approximately 70% of this value, that is, 3000 mAh/g, constant-current charge of the battery according to Sample No. 1 was performed at a current value of 20 hour rate, that is, 0.05 C rate. The charge was ended when the potential of the working electrode with respect to the counter electrode reached −0.62 V Next, discharge was performed at a current value of 0.05 C, and the discharge was ended at a voltage of 1.4 V. The initial discharge capacity obtained was converted per unit mass of silicon and per unit area of silicon. The results are shown in Table 2 and FIG. 4. Regarding the battery according to Sample No. 1, the test conditions for the above charge and discharge test are the same as the test conditions for a charge and discharge test in which the battery is charged to 0 V with respect to the potential of metallic lithium and then discharged to 2.02 V

### <<Samples No. 2 to No. 6>>

Batteries according to Samples No. 2 to No. 5 were obtained by the same method as in Sample No. 1, except that the thickness of the electrolytic copper foil and the conditions for silicon thin film formation were adjusted to the conditions shown in Table 1. A battery according to Sample No. 6 was obtained by the same method as in Sample No. 1, except that the conditions for silicon thin film formation were changed to the conditions shown in Table 1 and a stainless steel foil having a surface roughened with sandpaper #2000 was used as the negative electrode current collector. In addition, a charge and discharge test was performed for the batteries according to Samples No. 2 to No. 5 by the same method as in Sample No. 1. The results are shown in Table 2 and FIG. 4. The content of silicon in the negative electrode active material layers according to Samples No. 2 to No. 5 was 95 mass % or more.

### <<Sample No. 7>>

### [Production of Negative Electrode Material]

A sulfide solid electrolyte material and a powder of silicon were weighed and added to an agate mortar such that the ratio of the mass of silicon to the total of the mass of the sulfide solid electrolyte material and the powder of silicon was 70 mass %. The powder of silicon had an average particle diameter of 2.5 m. Thus, a negative electrode material according to Sample No. 7 was produced.

### [Production of Battery]

In an electrically insulating cylinder, 80 mg of Li₂S—P₂S₅, 1.64 mg of the negative electrode material according to Sample No. 7, and an electrolytic copper foil having a thickness of 10 μm were stacked in this order to obtain a mixture. This mixture was pressure-molded at a pressure of 370 MPa to produce a stack composed of a negative electrode and a solid electrolyte layer. A battery according to Sample No. 7 was obtained by the same method as in Sample No. 1, except that the stack was used.

### <<Samples No. 3-1 to No. 5-4>>

Batteries according to Samples No. 3-1 to No. 5-4 were obtained by the same method as in Sample No. 1, except that the negative electrodes according to Samples No. 3 to No. 5 were heat-treated under the conditions shown in Table 3.

### <<Sample No. 1-5>>

### [Production of Positive Electrode]

Metallic lithium having a thickness of 300 μm was punched out to have a diameter of 17 mm. This metallic lithium was attached to the inner surface of a sealing plate made of stainless steel (SUS) to produce a positive electrode according to Sample No. 1-5. At this time, no current collector was disposed between the metallic lithium and the sealing plate.

### [Preparation of Nonaqueous Electrolyte Solution]

A separator was disposed on metallic lithium. The separator used was a microporous film (thickness: 17.6 μm) made of polyethylene manufactured by Asahi Kasei Chemicals Corporation. On the separator, a negative electrode according to Sample No. 1-5 that had been punched out to have a circular shape with a diameter of 9.4 mm was disposed. Subsequently, a nonaqueous electrolyte solution was dropped. The nonaqueous electrolyte solution was prepared by dissolving LiPF₆ at a concentration of 1.5 mol/L in a mixed solvent of ethylene carbonate, ethyl methyl carbonate, and diethyl carbonate in a volume ratio of 3:5:2.

### [Production of Battery]

A positive electrode material, the nonaqueous electrolyte solution, and the negative electrode according to Sample No. 1-5 were disposed in a battery case. Next, to adjust the thickness of an electrode plate group, a disc spring was disposed on the negative electrode current collector, and a battery case made of stainless steel was disposed on the disc spring. A caulking machine was used to caulk opening end portions of the battery cases via an electrically insulating packing made of polypropylene to produce a coin-type battery according to Sample No. 1-5.

### <<Samples No. 3-5 to No. 5-7>>

Coin-type batteries according to Samples No. 3-5 to No. 5-7 were obtained by the same method as in Sample No. 1-5, except that the negative electrodes and the conditions for heat treatment were changed to those described in Table 4. The sign “-” in the columns of the conditions for heat treatment in Table 4 indicates that no heat treatment was performed.

### [Charge and Discharge Test]

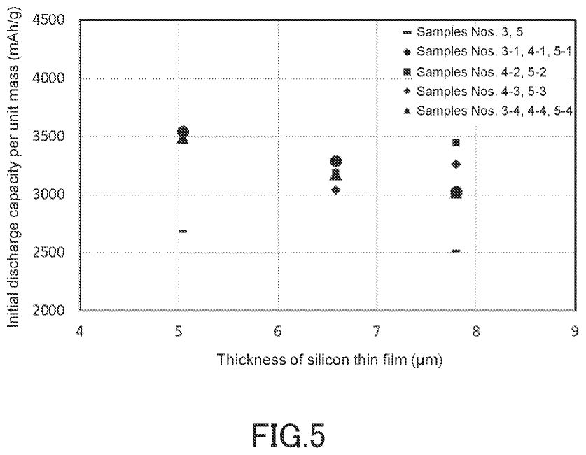

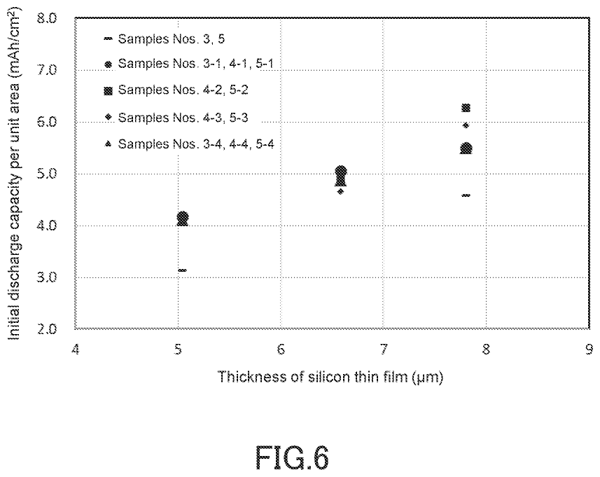

A charge and discharge test was performed for the batteries according to Samples No. 7 and No. 3-1 to No. 5-4 by the same method as in Sample No. 1. In the charge and discharge test for the coin-type batteries according to Samples No. 3-5 to No. 5-7, metallic lithium was used as the counter electrode. Thus, the charge and discharge test was performed for the coin-type batteries according to Samples No. 3-5 to No. 5-7 by the same method as in the battery according to Sample No. 1, except that the conditions for the charge and discharge test were changed to those in which constant-current charge was performed to 0 V with respect to the potential of the metallic lithium and subsequently discharge was performed to 2 V. The results are shown in Tables 3 to 5 and FIGS. 5 and 6.

### [Evaluation of Characteristics of Initial Charge and Discharge Capacities]

The theoretical capacity of silicon in the negative electrode active material is 4200 mAh/g. With respect to the capacity equal to approximately 70% of this value, that is, 3000 mAh/g, constant-current charge was performed at a current value of 0.05 C rate. The charge was ended when the potential of the working electrode with respect to the LiIn counter electrode, reached −0.62 V. Next, discharge was performed at a current value of 0.05 C, and the discharge was ended at a voltage of 1.4 V. Thus, the characteristics of the initial charge and discharge capacities were evaluated.

The obtained initial charge capacity and initial discharge capacity were converted per unit mass of silicon and per unit area of silicon.

### [Evaluation of Charge and Discharge Cycle Characteristics]

Evaluation of the charge and discharge cycle characteristics was performed for the batteries for which the above characteristics of the initial charge and discharge capacities had been evaluated. Constant-current charge was performed at a current value of 0.3 C with respect to the capacity of 3000 mAh/g. The charge was ended when the potential of the working electrode with reference to the LiIn counter electrode reached −0.62 V.

Next, constant-voltage charge was performed at a constant voltage of −0.62 V until the current value attenuated to 0.05 C. Subsequently, discharge was performed at a current value of 0.3 C rate, and the discharge was ended at a voltage of 1.4 V. This charge and discharge cycle was repeated. The discharge capacity after a predetermined number of cycles with respect to the initial discharge capacity was defined as the capacity retention ratio. The results are shown in Tables 3 to 5.

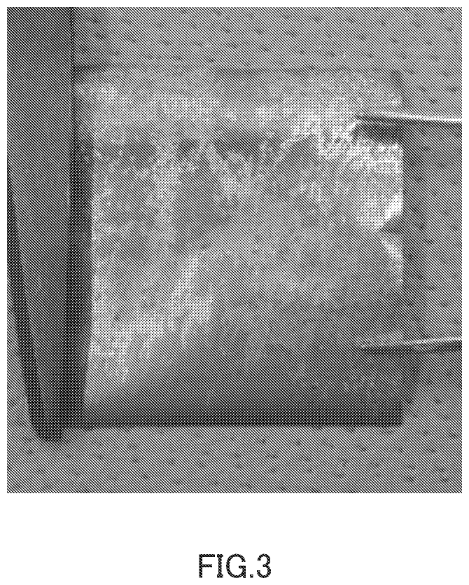

FIG. 3 is a photograph of the surface of a negative electrode according to Sample No. 6. As shown in FIG. 3, in Sample No. 6, the silicon thin film was formed on the stainless steel foil, however the silicon thin film was peeled off from the stainless steel foil. Thus, the battery according to Sample No. 6 could not be produced, and the charge and discharge test could not be performed. In Sample No. 6, the silicon thin film had a thickness of approximately 6 m.

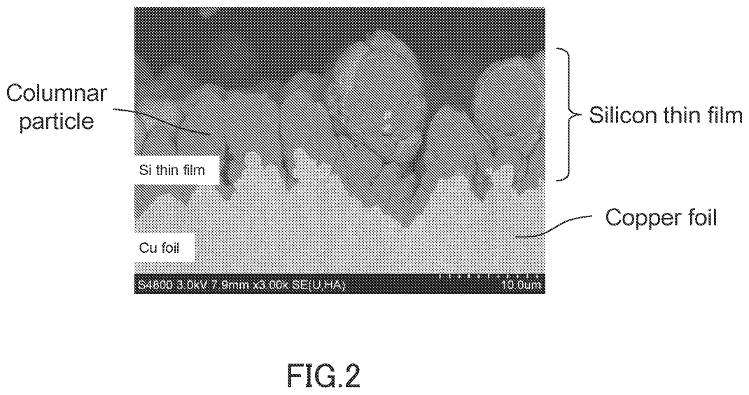

In contrast, in the negative electrodes according to Samples No. 1 to No. 5, the silicon thin film formed on the copper foil was not peeled off. FIG. 2 is an image of a cross section of the negative electrode according to Sample No. 4 observed with a scanning electron microscope (SEM). As shown in FIG. 2, in Sample No. 4, the silicon thin film was formed on the copper foil. Since the electrolytic copper foil having a surface roughened by depositing copper through an electrolytic process was used as the negative electrode current collector, unevenness was formed on the surface of the copper foil. This is considered to have enabled the adhesion between the copper foil and the silicon thin film to be enhanced. In addition, using a method such as sputtering in silicon thin film formation generates heat. Accordingly, copper included in the copper foil can diffuse into the silicon thin film. This is considered to have enabled the adhesion between the copper foil and the silicon thin film to be more fully enhanced.

In Sample No. 5, the silicon thin film formed on the copper foil had a thickness of 7.80 m. Thus, using the copper foil as the negative electrode current collector enabled an increase in thickness of the silicon thin film.

FIG. 4 is a graph showing the relationship between the thickness of the negative electrode active material layer and the initial discharge capacity in the batteries according to Samples No. 1 to No. 3 and Sample No. 5. In FIG. 4, the horizontal axis represents the thickness of the silicon thin film, and the vertical axis represents the initial discharge capacity per unit mass (mAh/g) or the initial discharge capacity per unit area (mAh/cm²). As shown in FIG. 4 and Table 2, the batteries according to Samples No. 1 to No. 3 and Sample No. 5 had a high initial discharge capacity.

FIG. 5 is a graph showing the relationship between the thickness of the negative electrode active material layer and the initial discharge capacity per unit mass in the battery according to each of the samples. In FIG. 5, the horizontal axis represents the thickness of the silicon thin film, and the vertical axis represents the initial discharge capacity per unit mass (mAh/g). FIG. 6 is a graph showing the relationship between the thickness of the negative electrode active material layer and the initial discharge capacity per unit area in the battery according to each of the samples. In FIG. 6, the horizontal axis represents the thickness of the silicon thin film, and the vertical axis represents the initial discharge capacity per unit area (mAh/cm²). As shown in Table 3, the batteries according to Samples No. 3-1 to No. 5-4 had an initial discharge capacity of 3000 mAh/g or more and 4 mAh/cm² or more. In the batteries according to Samples No. 3-1 to No. 5-4, the negative electrodes had been heat-treated. For example, since a copper element easily diffuses inside silicon, copper included in the current collector is considered to diffuse into silicon included in the negative electrode active material layer by the heat treatment. This is considered to have enhanced the electron conductivity of the negative electrode active material layer. The all-solid-state battery according to the present embodiment can have an ion conduction path only on the contact surface between the solid electrolyte layer and the negative electrode active material layer. However, it is considered that ensuring the conduction paths for ions and electrons in the negative electrode active material layer contributed to the increase in initial charge and discharge capacities. In addition, it is considered that, owing to such a configuration, the batteries according to Samples No. 3-1 to No. 5-4 had high cycle characteristics.

As shown in Table 3, in the batteries according to Samples No. 3-1 to No. 5-4, the capacity retention ratio after 50 cycles was 80% or more. In the batteries according to Samples No. 3-1 to No. 5-4, the sulfide solid electrolyte was not substantially included inside the negative electrode active material layer. That is, in the batteries according to Samples No. 3-1 to No. 5-4, the sulfide solid electrolyte could be in contact only with the negative electrode active material layer. Thus, in the batteries according to Samples No. 3-1 to No. 5-4, the contact between the copper foil forming the negative electrode current collector and the sulfide solid electrolytes was suppressed. In the batteries according to Samples No. 3-1 to No. 5-4, this is considered to have suppressed generation of copper sulfide that could become a resistance layer in a negative electrode layer. It is considered that, owing to this, the batteries according to Samples No. 3-1 to No. 5-4 to had high cycle characteristics.

As shown in Table 4, the batteries according to Samples No. 3-5 to No. 5-7 had an initial discharge capacity of 3000 mAh/g or more. In addition, it was determined that, in the batteries according to Samples No. 3-5 to No. 5-7, the initial discharge capacity was less likely to decrease even with an increase in thickness of the negative electrode active material layer. In the batteries including the nonaqueous electrolyte solution, the nonaqueous electrolyte solution easily permeates into the negative electrode active material layer, so that an ion conduction path can be formed over the entire negative electrode active material layer. This is considered to have allowed the batteries including the nonaqueous electrolyte solution to exhibit an excellent initial discharge capacity. In contrast, the batteries according to Samples No. 3-6 and No. 5-7 had a lower capacity retention ratio than the batteries including the solid electrolyte layer. In Sample No. 3-6, the capacity retention ratio after 40 cycles was 40%. In Sample No. 5-7, the capacity retention ratio after 35 cycles was 26%. In the batteries including the nonaqueous electrolyte solution, the entire negative electrode active material could react with the nonaqueous electrolyte solution due to charge and discharge. This is considered to have inactivated silicon included in the negative electrode active material. From the above results, it is considered difficult for batteries including a nonaqueous electrolyte solution to have both a high energy density and excellent cycle characteristics.

As shown in Table 5, the battery according to Sample No. 7 included the sulfide solid electrolyte in the negative electrode active material layer, and accordingly had an initial discharge capacity of 3000 mAh/g or more. In contrast, in the battery according to Sample No. 7, a repetition of the charge and discharge could cause a reaction between the copper foil forming the negative electrode current collector and the sulfide solid electrolyte included inside the negative electrode active material to generate copper sulfide. Copper sulfide can increase the resistance at the interface between the negative electrode current collector and the negative electrode active material layer. This is considered to have caused a lower capacity retention ratio of the battery according to Sample No. 7 than those of the batteries including the solid electrolyte layer.

TABLE 1

| | Sample | Sample | Sample | Sample | Sample | Sample |
|---|---|---|---|---|---|---|
| | No. 1 | No. 2 | No. 3 | No. 4 | No. 5 | No. 6 |
| Power source | RF | RF | RF | RF | RF | RF |
| Power (W) | 200 | 200 | 200 | 200 | 200 | 200 |
| Ar flow rate | 90 | 90 | 90 | 90 | 90 | 90 |
| (seem) | | | | | | |
| Time of thin film | 105 | 210 | 584 | 701 | 934 | 701 |
| formation (min.) | | | | | | |
| Pressure before | 1.0 × 10⁻³ | 1.0 × 10⁻³ | 1.0 × 10⁻³ | 1.0 × 10⁻³ | 1.0 × 10⁻³ | 1.0 × 10⁻³ |
| thin film formation | | | | | | |
| (Pa) | | | | | | |
| Pressure during | 2.5 × 10⁻¹ | 2.5 × 10⁻¹ | 2.44 × 10⁻¹ | 2.43 × 10⁻¹ | 2.44 × 10⁻¹ | 2.43 × 10⁻¹ |
| thin film formation | | | | | | |
| (Pa) | | | | | | |
| Type of negative | Copper | Copper | Copper | Copper | Copper | Stainless |
| electrode current | foil | foil | Foil | foil | foil | steel foil |
| collector | | | | | | |
| Thickness of | 25 | 25 | 46 | 46 | 46 | 20 |
| negative electrode | | | | | | |
| current collector | | | | | | |
| after roughening | | | | | | |
| (pm) | | | | | | |
| Surface density of | 0.199 | 0.423 | 1.17 | 1.38 | 1.82 | — |
| silicon thin film | | | | | | |
| (mg/cm²) | | | | | | |
| Thicknessof | 0.852 | 1.82 | 5.04 | 6.53 | 7.80 | — |
| silicon thin film | | | | | | |
| (pm) | | | | | | |

TABLE 2

| | Initial | | Initial | |
|---|---|---|---|---|
| | charge capacity | | discharge capacity | |
| | mAh/g | mAh/cm² | mAh/g | mAh/cm² |
| Sample No. 1 | 4073 | 0.80 | 3906 | 0.78 |
| Sample No. 2 | 3901 | 1.65 | 3707 | 1.57 |
| Sample No. 3 | 2888 | 3.99 | 2683 | 3.15 |
| Sample No. 5 | 2800 | 5.09 | 2518 | 4.58 |

TABLE 3

| | | Conditions | Initial charge | | Initial discharge | | Capacity |
|---|---|---|---|---|---|---|---|
| | Negative | for heat | capacity | | capacity | | retention |
| | electrode | treatment | mAh/g | mAh/cm² | mAh/g | mAh/cm² | ratio (%) |
| Sample | Sample | 170° C. | 3776 | 4.43 | 3548 | 4.17 | 91 |
| No. 3-1 | No. 3 | 2 hours | | | | | |
| Sample | Sample | 170° C. | 3519 | 5.39 | 3293 | 5.05 | 87 |
| No. 4-1 | No. 4 | 2 hours | | | | | |
| Sample | Sample | 170° C. | 3373 | 6.13 | 3026 | 5.50 | 85 |
| No. 5-1 | No. 5 | 2 hours | | | | | |
| Sample | Sample | 170° C. | 3424 | 5.25 | 3192 | 4.89 | 86.8 |
| No. 4-2 | No. 4 | 20 hours | | | | | |
| Sample | Sample | 170° C. | 3789 | 6.89 | 3450 | 6.27 | 85 |
| No. 5-2 | No. 5 | 20 hours | | | | | |
| Sample | Sample | 210° C. | 3257 | 4.99 | 3038 | 4.66 | 83 |
| No. 4-3 | No. 4 | 2 hours | | | | | |
| Sample | Sample | 210° C. | 3572 | 6.49 | 3260 | 5.93 | — |
| No. 5-3 | No. 5 | 2 hours | | | | | |
| Sample | Sample | 250° C. | 3714 | 4.36 | 3492 | 4.10 | 92 |
| No. 3-4 | No. 3 | 2 hours | | | | | |
| Sample | Sample | 250° C. | 3388 | 5.19 | 3179 | 4.87 | 88 |
| No. 4-4 | No. 4 | 2 hours | | | | | |
| Sample | Sample | 250° C. | 3301 | 6.00 | 3024 | 5.50 | 90 |
| No. 5-4 | No. 5 | 2 hours | | | | | |

TABLE 4

| | | Conditions | Initial charge | | Initial discharge | | Capacity |
|---|---|---|---|---|---|---|---|
| | Negative | for heat | capacity | | capacity | | retention |
| | electrode | treatment | mAh/g | mAh/cm² | mAh/g | mAh/cm² | ratio (%) |
| Sample | Sample | — | 3875 | 0.85 | 3534 | 0.78 | — |
| No. 1-5 | No. 1 | | | | | | |
| Sample | Sample | — | 3731 | 4.38 | 3534 | 4.15 | — |
| No. 3-5 | No. 3 | | | | | | |
| Sample | Sample | — | 3805 | 5.24 | 3590 | 4.95 | — |
| No. 4-5 | No. 4 | | | | | | |
| Sample | Sample | — | 3263 | 5.39 | 3121 | 5.15 | — |
| No. 5-5 | No. 5 | | | | | | |
| Sample | Sample | 170° C. | 3679 | 4.32 | 3481 | 4.09 | 40 |
| No. 3-6 | No. 3 | 20 hours | | | | | |
| Sample | Sample | 250° C. | 3291 | 5.05 | 3141 | 4.82 | — |
| No. 4-7 | No. 4 | 2 hours | | | | | |
| Sample | Sample | 250°C. | 3434 | 6.24 | 3258 | 5.94 | 26 |
| No. 5-7 | No. 5 | 2 hours | | | | | |

TABLE 5

| | Initial | | Initial discharge | | Capacity |
|---|---|---|---|---|---|
| | charge capacity | | capacity | | retention |
| | mAh/g | mAh/cm² | mAh/g | mAh/cm² | ratio (%) |
| Sample No. 7 | 3442 | 7.60 | 3224 | 7.16 | 53 |

### INDUSTRIAL APPLICABILITY

The battery of the present disclosure can be utilized, for example, for all-solid-state lithium-ion secondary batteries and the like.

What is claimed is:

1. A battery comprising:
a positive electrode;
a negative electrode; and
a solid electrolyte layer positioned between the positive electrode and the negative electrode, wherein
the solid electrolyte layer comprises a solid electrolyte having lithium-ion conductivity,
the negative electrode comprises:
a negative electrode current collector; and
a negative electrode active material layer positioned between the negative electrode current collector and the solid electrolyte layer,
the negative electrode active material layer comprises a plurality of columnar particles and is substantially free of an electrolyte, and
the columnar particles comprise silicon as a main component.

2. The battery according to claim 1, wherein
the negative electrode active material layer comprises a structure in which the plurality of columnar particles are arrayed along a surface of the negative electrode current collector to cover the surface.

3. The battery according to claim 1, wherein
the negative electrode active material layer has a thickness of 4 μm or more and 20 μm or less.

4. The battery according to claim 1, wherein
a content of the silicon in the negative electrode active material layer is 95 mass % or more.

5. The battery according to claim 1, wherein
the solid electrolyte comprises a sulfide.

6. The battery according to claim 1, wherein
the negative electrode current collector comprises, as a main component, copper or nickel.

7. The battery according to claim 6, wherein
the negative electrode current collector comprises copper as the main component.

8. The battery according to claim 1, wherein
the negative electrode active material layer comprises copper.

9. The battery according to claim 1, wherein
when constant-current charge is performed to −0.62 V at a current value of 0.05 C by using the negative electrode and a LiIn counter electrode and subsequently constant-current discharge is performed to 1.4 V at a current value of 0.05 C, a discharge capacity of the battery is 2500 mAh/g or more and 3 mAh/cm² or more.

10. The battery according to claim 9, wherein
the discharge capacity of the battery in the constant-current discharge is 3000 mAh/g or more and 4 mAh/cm² or more.

11. The battery according to claim 10, wherein
the discharge capacity of the battery in the constant-current discharge is 3000 mAh/g or more and 5 mAh/cm² or more.

12. A method of manufacturing the battery according to claim 1, the method comprising
depositing the silicon on the negative electrode current collector by sputtering.

13. The method according to claim 12 comprising
heat-treating the silicon at 300° C. or less after the sputtering.
